(19) United States
(12) Patent Application Publication
(10) Pub. No.: US 2007/0073653 A1
(43) Pub. Date: Mar. 29, 2007

(54) Patent related search method and system

(75) Inventor: Francis John Raab, Edwards, IL (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 11/238,037

(22) Filed: Sep. 29, 2005

(51) Int. Cl. G06F 17/30

(52) U.S. Cl. 707/3

(57) ABSTRACT

A method and system for searching patent-related documents includes selecting a portion of a selected claim of a patent and selecting a portion of a disclosure of the patent. The method further includes comparing the claim portion with the disclosure portion. Based on the comparison, claim interpretation data may be determined that is associated with the portion of the claim. The method may also include searching a database for patent-related documents relevant to the selected claim based on the claim interpretation data.

### TECHNICAL FIELD

This disclosure relates generally to data search processes, and more particularly, to a method of searching for patents and related documents.

### BACKGROUND

A patent is a published document issued by a government entity and represents the rights of the patent owner to exclude others from making, using, selling, or offering to sell the patented invention for a predetermined time within the jurisdiction of the government entity. A patent generally includes different sections, such as claims, drawings, and a specification, which collectively constitute the disclosure of the patent. The claims include text that generally define the metes and bounds of the patented invention. The specification and drawings include detailed technical description of the patented invention.

Generally, a government entity will not issue a patent unless it claims an invention that is novel and has inventive step (i.e., non-obvious). Therefore, when preparing a patent application for consideration by the government entity, a patent applicant may benefit from being aware of published information that is associated with the field of technology of the application. This information may include, for example, issued patents by the same or different government entities, published patent applications provided by the same or different government entities, and non-patent literature, such as articles, on-line web page content, textbooks, and any other type of printed publication. Generally, this information is identified by the label “prior art.” Patent applicants may determine the relevant prior art in the field of their proposed invention by searching repositories of patents, patent applications, and other printed publications related to their invention. Typically, this search is done electronically via one or more databases that store information corresponding to the prior art. Also, a government entity that issues patents may also have a similar need to review prior art relevant to a patent application under review in order to determine the novelty or nonobviousness of the application.

In addition to concerns associated with patent applications, other persons or entities (e.g., business, government, etc.) may be interested in prior art related to the claims of an issued patent. For example, an accused infringer of an issued patent may wish to locate one or more documents that demonstrate the obviousness or lack of novelty of one or more claims of the patent. Therefore, there exists a need for searching tools that may help an entity locate patent related documents (e.g., patents, published patent applications, technical documents, textbooks, and any type of published document) that may be related to a particular invention or an issued patent.

Many systems and methods have been developed to address the above concerns. Typically, these solutions involve techniques for searching one or more databases populated with publications including patents, patent applications, and other printed publications. Various methods exist for searching these databases to locate relevant information (e.g., prior art). Some of these methods may include the use of keyword searches. For example, a user leveraging a computer system connected to a database electronically storing publication documents may use a keyword search including Boolean operators (e.g., AND, OR, etc.) to link query keywords together. While efficient in locating large sets of result documents pertinent to the restrictions set forth in the Boolean operator query, more robust techniques have evolved to simplify a user's role in constructing search queries. Among these techniques are natural language searches and concept-based search techniques. A natural language search is a search performed by a computer system based on a user's query including words, phrases, etc., and no logical operators. The computer system may use programmed logic to determine one or more keywords from a natural language query based on the position of terms in a sentence or phrase within the query. The computer system may then use the keywords to search one or more databases for relevant information, such as prior art. Concept-based searches, however, determine the meaning of a user query by linking various terms in the user's query to identify a particular subject. Based on the identified subject, a computer system may identify terms related to the subject and subsequently search one or more databases using the identified terms.

One example of a concept-based search technique is the method used by PatentCafe® (www.patentcafe.com). The concept-based search technique used by PatentCafe uses a mathematical algorithm that emulates a human neural net. In other words, it learns the natural meaning of words and phrases in a user query and builds relational intelligence for searching. For example, PatentCafe may treat a query term “library” as a phrase and return search results including, for example, library, libraries, building with books, book shelf, notice, stemmer, etc.

Although concept-based search processes, such as PatentCafe, provide alternative methods to generate search terms for locating information, such as prior art, they have some disadvantages. For instance, in order to obtain accurate search results, a concept-based search engine may have to use many words that refer to the subject identified by a user's query. This may require a user to spend time developing a list of words to be used by the search engine. Furthermore, a concept-based search technique may also not be particularly helpful in searching prior art pertaining to patents because, among other things, such techniques do not determine the relevance of a patent claim in context of the disclosure of the patent or patent application including the claim. Therefore, inaccurate searches may result, thus requiring additional time to modify the initial search query.

Further, employing such techniques to formulate a search query based on terms solely obtained from a patent specification also may not yield accurate search results because the specification may include terms that are not relevant to the novelty of the claimed invention. For example, the specification may include portions that describe prior art and do not relate to embodiments of a claimed invention. Therefore, there is a need for a search method that forms search queries based in part on the interpretation of claim terms of a patent or patent application in the context of the disclosure of the patent or the patent application.

Methods, systems, and articles of manufacture consistent with certain disclosed embodiments may solve one or more of the problems set forth above

### SUMMARY OF THE INVENTION

Systems and methods are provided for searching patent-related documents. In one embodiment, a method is disclosed that includes selecting a portion of a selected claim of a patent and selecting a portion of a disclosure of the patent. The method further includes comparing the claim portion with the disclosure portion. Based on the comparison, claim interpretation data may be determined that is associated with the portion of the claim. The method may also include searching a database for patent-related documents relevant to the selected claim based on the claim interpretation data.

In another embodiment, a system is provided for searching patent-related documents. The system may include a computer system and a database system including patent-related documents. The computer system may be configured to select a portion of a selected claim of a patent and select a portion of a disclosure of the patent. Further, the computer system may compare the claim portion with the disclosure portion. Based on the comparison, the computer system may determine claim interpretation data associated with the portion of the claim. Moreover, the computer system may be further configured to send a search command to the database system to search for patent-related documents relevant to the selected claim portion based on the claim interpretation data.

In another embodiment, a method, and a computer-readable medium including instructions for performing the method, are provided for searching patent-related documents associated with a selected claim term within a patent. The method may be performed automatically by a computer system executing software and includes determining the context of the selected claim term in relation to a disclosure of the patent. The method may also include generating a search query based on the determined context of the selected claim term and searching a database to identify one or more of the patent-related documents that are relevant to the search query.

### BRIEF DESCRIPTION OF THE DRAWINGS

FIG. 1 illustrates a block diagram of an exemplary system consistent with certain disclosed embodiments;

FIG. 2 illustrates a flowchart of an exemplary search and database building process consistent with certain disclosed embodiments;

FIG. 3 illustrates an block diagram of an exemplary comparison process consistent with certain disclosed embodiments; and

FIG. 4 illustrates a block diagram of an exemplary claim interpretation process consistent with certain disclosed embodiments.

### DETAILED DESCRIPTION

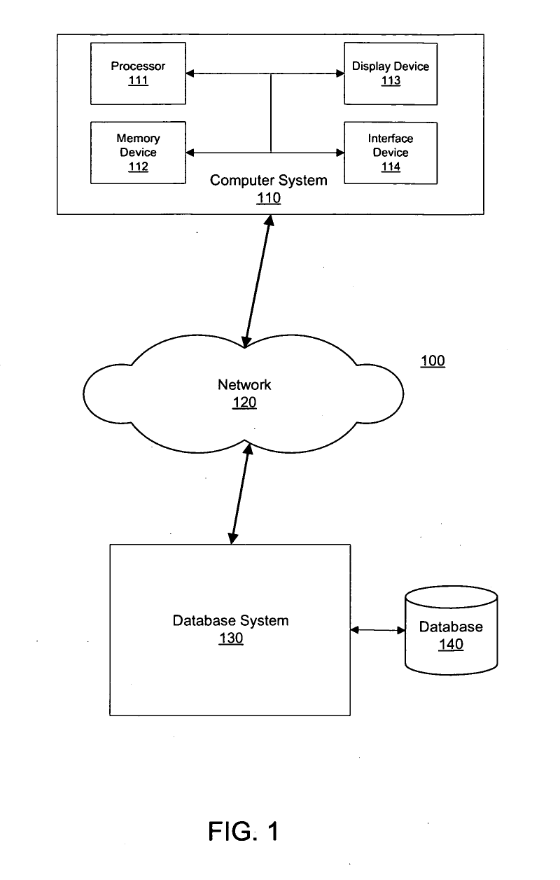

FIG. 1 illustrates an exemplary system environment 100 in which features and principles consistent with the disclosed embodiments may be implemented. As shown in FIG. 1, system 100 may include a computer system 110, network 120, and database system 130.

Computer system 110 may be a computing system that is operated by a user, such as a laptop computer, desktop computer, workstation, mainframe, etc. Computer system 110 may include, for example, a processor 111, memory device, 112, display device 113, and an interface device 114. Processor 111 may be one or more processor devices, such as a microprocessor, that execute program instructions to perform various functions. Memory device 112 may be one or more storage devices that maintain data (e.g., instructions, software applications, etc.) used by processor 111. For example, memory device 112 may include browser software that enables computer system 110 to retrieve content from external sources, such as a remote database system. Memory device 112 may also include software that performs, when executed by processor 111, search processes consistent with certain embodiments disclosed below. Additionally, memory device 112 may include software that performs processes, when executed by processor 111, that collaborates with another computer system to perform search processes consistent with certain disclosed embodiments. Display device 113 may be any known type of display device that presents information to the user operating computer system 110. Interface device 114 may be one or more known interface modules that facilitate the exchange of data between the internal components of computer system 110 and external components, such as database system 130. Further, interface device 114 may include a network interface device that allows user system to receive and send data to and from network 120.

Network 120 may be any type of network that facilitates communications between remote components. For example, network 120 may be a local area network (LAN), a wide area network (WAN), a dedicated intranet, the Internet, and/or a wireless network. Network 120 may be implemented using wired or wireless communication mediums or a combination of both. Further, network 120 may represent a communication path that interfaces components within a single computing environment, such as computer system 110 and database system 130. In this embodiment, system environment 100 may represent a single computing system.

Database system 130 may represent one or more storage devices configured in any type of known storage system configuration that facilitates the locating, accessing, and retrieving of data stored in the storage devices, (e.g., Sybase, Oracle, MySQL, SQL, Access, etc.). In one exemplary embodiment, database system 130 interfaces with, or includes, database 140 that may store information that may be retrieved and processed by computer system 110. Database 140 may be one or more storage devices that store information, such as a CD-ROM, a DVD, a floppy disk, a hard disk, a flash memory device, a magnetic card, a tape drive, an array of memory devices, etc. Database 140 may include data structures that are configured in a searchable format. These data structures may have various degrees of accessibility. For example, in an exemplary embodiment, database 140 may include a simple text-based data file that holds data. Database system 130 may parse the data based on a text-based search string that includes terms that may be included in the data file. The data file may reside on hardware that may store other types of information, such as files that are not relevant to the search. Further, any type of information may be stored in database 140, such as text files, graphical image-related data, audio data, etc. that may or may not be used in processing search requests.

Alternatively, database 140 may include more complex data structures, such as a Relational Database Management System (RDBMS). The data tables may be built using specialized database software. Database system 130 may execute the specialized database software to search database 140 based on search queries written in languages such as, for example, Structured Query Language (SQL). In one embodiment, database 140 may be configured to store information associated with patents and patent applications, articles, research publications, technical bulletins, and any other type of information that may be related to a prior art search performed by system environment 100 consistent with the disclosed embodiments.

One skilled in the art would appreciate that system environment 100 may be implemented in a number of different configurations. For example, computing system 110 and database system 130 may be directly connected within a single computing environment. Additionally, computing system 110 may be included within database system 130, or vice versa, thus allowing database system 130 to receive an internal query request from a user operating computer system 110. Further, additional components may be included in system 100, such as one or more additional database systems that may exchange information with each other and computing system 110.

In one embodiment of the invention, exemplary system environment 100 may be configured to process one or more query requests received from a user operating computer system 110 or generated by a software process executed by computer system 110. In the exemplary embodiments described below, a query request is associated with a prior art search associated with a patent, patent application, or related patent documentation. One skilled in the art, however, would appreciate that the type of query request and the information obtained from the query may vary and the following description applies to these various queries and information.

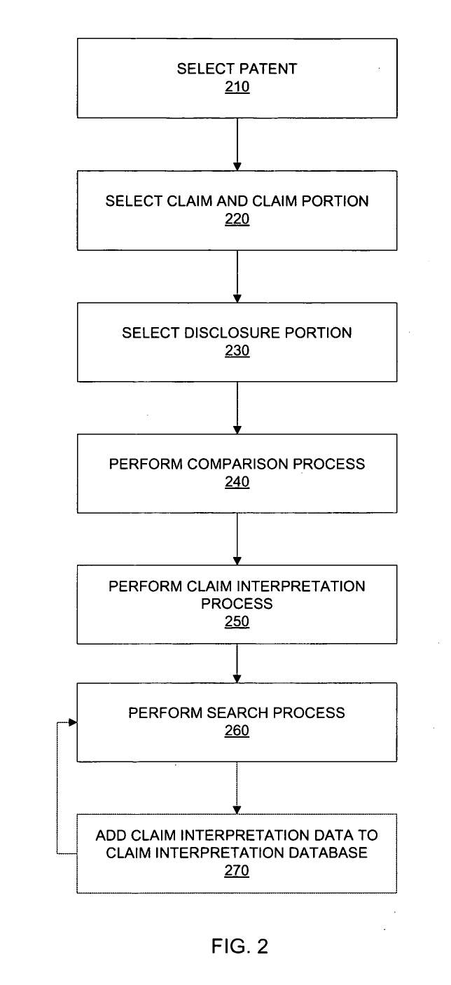

FIG. 2 illustrates a flowchart of an exemplary search and database building process consistent with certain disclosed embodiments. The following description is associated with a prior art search based on a search request corresponding to a patent having various portions, including a specification, drawings, and a claims portion. The disclosed embodiments are not limited to the following example, and other types of search requests and results may be generated and/or processed.

In one embodiment, the search and database building process may begin with a user operating computer system 110 or a software process executed by computer system 110 selecting a patent that is the subject of a potential search query (Step 210). The selected patent, as described in the following embodiments, is not limited to a patent, but may also represent a patent application. As such, the selected patent in the context of the following description may refer to a patent or a patent application.

The selected patent may include different portions that form the disclosure of the patent, such as a specification, drawings, and claims. The specification includes text that describes one or more aspects of an invention associated with the patent. The drawings include figures, such as image data and text (e.g., alphanumeric data) describing elements depicted in the figures. A patent claim refers to a claim listed in the claim portion of a patent or patent application document. A patent claim includes text describing aspects of an invention disclosed in the patent's specification. This text may include terms that are unique to the patent or terms that have ordinary meanings and/or are used and known within the technical field associated with the inventions disclosed by the patent's specification.

The claim portion of a patent may include one or more independent claims. These are claims that include text that describes a particular scope of an invention and do not depend on any other claims in the patent. Further, the claim portion may include one or more dependent claims, which are claims that depend from another claim, such as an independent claim or another dependent claim. A dependent claim includes text that describes additional scope of an invention claimed in its parent claim. Accordingly, the scope of a dependent claim may include the scope of any claim from which it depends and the additional scope associated with that dependent claim.

The search and database building process may then proceed with the user operating computer system 110 or software executed by processor 110 selecting a patent claim within the patent. Once selected, the software executed by processor 110 may select a portion of the selected patent claim (Step 220). The text of the identified portion of the claim is collected and stored in a memory location for subsequent processing. The selected portion of a claim may include some or all of the text representing the selected claim. Thus, a portion of a claim may include, for example, a term, a phrase, a clause in the claim, or the entire text of the claim. Computer system 110 may select the claim portion based on selection criteria designated by input from the user operating system 110 and/or by a selection process executed by processor 111. For example, a patent claim is generally structured in sections. One section, known as a preamble, includes text that describes the type of claim, such as “a method,” “a system,” “an apparatus,” “a computer-readable medium,” etc. Another section, known as the body of the claim, includes text further defining the scope of the claim. The body may be structured in separated subsections. For instance, the body of a claim may be configured as:

[TEXT];

[TEXT]; and

[TEXT].

The body may also be structured as a single block of text, such as:

[TEXT . . . TEXT].

As such, processor 111 may execute a software process that selects a portion of the selected claim based on structure of the claim identified by the user or a software executed process. For instance, the preamble, body, subsections of the body, or any combination thereof may be selected. Further, the executed software process may select the portion of the claim based on one or more selection criteria, such as a rule, based on the structure of the claim. For example, the software process may identify a subsection of claim based on the amount of text included in the subsection. Thus, a subsection of the body of the claim having more text than others may be given more weight by the software process than subsections having less text, or vice versa.

Further, as mentioned above, the software process may select the claim and/or portion of the claim based on selection criteria specified by the user with or without the aid of executed software processes. For example, an executed software process may aid in determining a relevant portion of a claim that may form the basis of a search query by selecting the claim portion based on input provided by the user to computer system 110 via an input device. The user input may indicate a type of prior art that is to be searched (e.g., prior art related to method claims, apparatus claims, etc.). In an exemplary embodiment, the user may provide input that represents a desire to search for prior art patents and other types of publications having disclosures related to an independent apparatus claim in the selected patent. Accordingly, the user may provide input criteria indicating that an independent apparatus claim should form the basis of the search. In response to this input, the executed software may select an independent apparatus claim, or a portion thereof, from a set of claims in the patent. In another exemplary embodiment, the executed software may select an independent method claim, or a portion thereof, from the patent in response to input from the user including criteria indicating that an independent method claim should form the basis of the search. In another embodiment, the executed software may select a dependent claim from the patent in response to user input including criteria for a selected dependent claim. One skilled in the art would realize that any type of rule or decision process may be implemented to select the portion of the claim, and the disclosed embodiments are not limited to the examples described above. For instance, the software process may select a claim or portion of the selected claim based on criteria set forth by other software processes executed by computer system 110.

At Step 230, processor 111 may execute a disclosure selection process that selects a portion of the disclosure of the patent. The selected portion of the disclosure may include the entire, or portions thereof, of the specification of the patent, other claims of the patent (e.g., one or more dependent or independent claims of the patent), text associated with the figures of the patent, etc. For example, the identified portion of the disclosure may include a portion of the specification of the patent, which includes one or more paragraphs of text describing the invention of the selected patent. The specification may include sections that are identified by heading, such as an abstract, a summary, a detailed description, a conclusion, tables, exemplary embodiments (e.g., first, second, third, etc.) etc. As such, the disclosure selection process may select one or more of the specification sections. The disclosure selection process may also perform a process that allows the user operating computer system 110 to select a portion of the disclosure. The disclosure selection process may store the text associated with the selected portion of the disclosure in a memory location for subsequent processing. One skilled in the art would realize that any type of rule or decision process may be implemented by the disclosure selection process to select the portion of the disclosure, and the disclosed embodiments are not limited to the examples described above.

At Step 240, processor 111 may perform a comparison process that compares the selected portion of the claim to the selected portion of the disclosure of the patent. The comparison process may implement techniques suitable to perform the comparison between the identified portion of the claim and disclosure. For instance, the comparison process may be configured as a computer program written in any type of computing language, such as C, C++, Pascal, Visual C++ or Visual Basic, etc. Alternatively, the comparison process may be configured with artificial intelligence or concept-based techniques used to perform the comparison between the selected portions. One skilled in the art will appreciate that any type of technique suitable to perform a comparison between the text of the identified portion of the claim and disclosure may be implemented by computer system 110.

The comparison process may be configured to retrieve and compare the text associated with the portions of the selected claim and disclosure. For example, if the selected claim portion is from an independent claim, the comparison process may compare the selected claim portion to one or more dependent claims, or portions thereof, that depend from the selected independent claim. In another exemplary embodiment, if a portion of a dependent claim is chosen as the basis of the search in Step 220, the comparison process may compare it to one or more dependent claims, or portions thereof, that depend from the identified dependent claim. In addition, the comparison process may be configured to identify a claim portion based on any other criteria that a searcher may find useful.

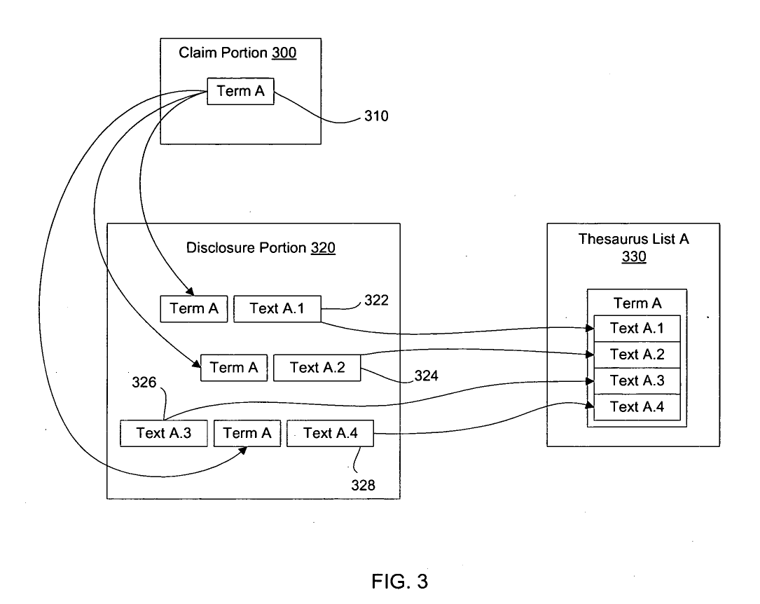

In one embodiment, the comparison process may use terms included in the selected claim portion as a link to terms within the selected portion of the disclosure. FIG. 3 illustrates a block diagram of an exemplary comparison process consistent with certain disclosed embodiments. For example, selected claim portion 300 may include a claim term A 310. This term may be located in various locations within selected disclosure portion 320. As shown in FIG. 3, term A 310 appears in disclosure portion 320 three times. The comparison process may identify term A 310 in disclosure portion 320 and contextually identify text surrounding the term that may identify or describe term A 310. For instance, in a first instance of term A 310 in disclosure portion 320, the comparison process may identify text A.1 322 that describes term A 310. In a second instance, the comparison process may identify text A.2 324 that also relates to the description of term A.1 310. Further, the comparison process may identify text A.3 326 and text A.4 328 that surrounds term A 310 in a third instance within disclosure portion 320. Based on the identified text associated with term A 310, the comparison process may form a thesaurus list 330 for term A 310. As shown, thesaurus list 330 includes text A.1, A.2, A.3, and A.4, identified as descriptive text associated with term A 310 within disclosure portion 320. Other terms within claim portion 300 may also be similarly processed by the comparison process to form one or more additional thesaurus lists for each of the other terms. The thesaurus list(s) may be stored in a memory location for subsequent processing by computer system 110.

Furthermore, criteria, such as ambiguity of a claim term, may be used to select claim terms for comparison with the selected disclosure portion. For example, the comparison process may select a claim term based on a pre-comparison process of the term to stored definitions or lists of predetermined terms. For instance, a claim term including the word “means,” such as “detecting means” may be designated as an ambiguous claim term by the comparison process based on the term “means” being included in a list of designated ambiguous terms. As such, the comparison process may search the selected disclosure for the term “detecting” or detect” (with or without the term “means”) to identify text in the selected disclosure that may describe the selected claim term. Other criteria may be employed by the disclosed embodiments to select claim terms for comparison. For example, the comparison process may identify keywords in a claim that may be compared to the rest of the patent or patent application.

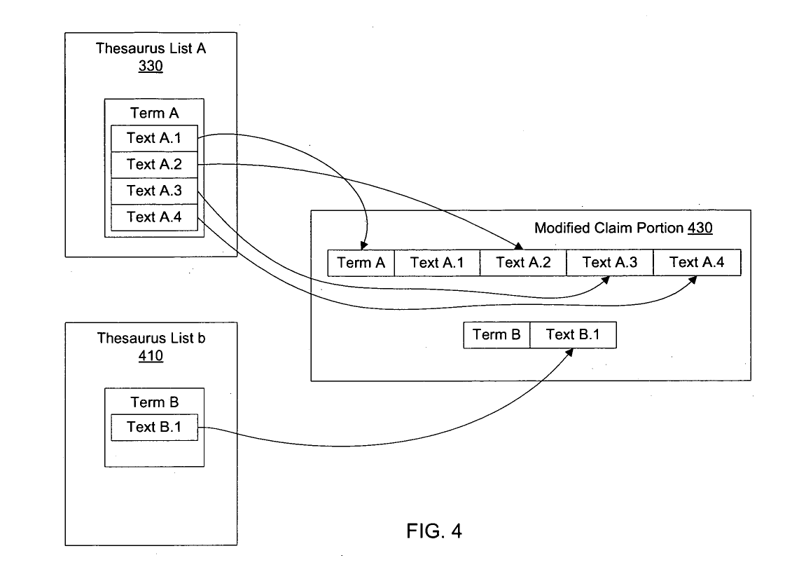

Once the comparison between the selected portion of the claim and the selected portion of the disclosure is complete, and one or more thesaurus lists are generated, computer system 110 may execute a claim interpretation process that determines an interpretation of the selected claim in the context of the patent (Step 250). In one embodiment, the claim interpretation may be data reflecting a modified version of the claim selected in Step 220. The modified version may be related to a meaning of the claim in the context of the patent based on the thesaurus list(s) generated for selected claim terms within the selected claim portion. FIG. 4 illustrates a block diagram consistent with this exemplary embodiment As shown, thesaurus list 330 and a second thesaurus list 410 may be used by the claim interpretation process to modify claim portion 300. For instance, term A 310 may be supplemented with text A.1, A.2, A.3, and A.4 and term B may be supplemented with text B.1. Thus, as shown, the claim interpretation process may substitute and/or add the descriptive text associated with selected claim terms A and B with claim portion 300 to form a modified claim portion 430. For example, suppose term A is “exhaust element” and terms “particulate trap” and “exhaust manifold” represent text A.1 and A.2, respectively. Because this text from the selected disclosure may describe the term “exhaust element,” in the context of the selected patent, the terms “particulate trap” and “exhaust manifold” are included in the selected claim to form a modified claim. Thus, modified claim portion 430 may represent an interpretation of a selected claim. It should be noted that terms other than those included in a thesaurus list and that are associated with a claim term may be included in the original claim to determine the claim interpretation data.

Based on the data generated by the claim interpretation process, computer system 110 may execute a search process to locate one or more prior art documents that are considered relevant to the selected patent or patent claim (Step 260). In one embodiment, the search process may generate one or more search queries based on the text associated with the modified selected claim portion generated by the claim interpretation process. For example, the search process may extract one or more keywords from the modified claim portion using one or more keyword extraction techniques. The search process may then link the extracted keywords to each other to develop a search query used to perform a search on database 130. In one embodiment, the search process may link the extracted keywords using, for example, Boolean operators (e.g., AND, OR, etc.).

In another exemplary embodiment, the search process may implement natural language search processes to generate the one or more search queries. As such, the search process may include software that, when executed by processor 111, determines keywords based on their position in the modified claim generated by the claim interpretation process. The keywords may then be used to perform a search on database 130.

In yet another exemplary embodiment, the search process may include a process, when executed by processor 111, that determines a concept related to the selected claim portion based on the claim interpretation data. For instance, the search process may include content search engine software, such as latent semantic filtering search software, that determines a concept associated with the selected claim portion based on relationships between text within the modified claim portion generated by the claim interpretation process. For example, consider a modified claim portion that includes the terms “bears” and “arms,” within a predetermined proximity of each other. The search process may determine the concept of the modified claim portion based on these terms and their proximity, which may include, for example, “carrying weapons.” Accordingly, the search process may generate a search query including the terms “bears,” “arms,” and “carrying weapons.” It should be noted that other techniques and search engine processes suitable for determining the concept and/or the meaning of the selected claim portion and/or claim term(s) may be implemented by the disclosed embodiments to generate one or more search queries.

Once the one or more search queries are formed, the search process may perform a search for prior art documents that are determined relevant to the search query terms. In one embodiment, the search process may execute search engine processes that search database 130 for one or more documents including text corresponding to the terms in the search query. In response to one or more search messages, database 130 may provide results of the search query request to computer system 110. A user operating computer system 110 may view the search results via display device 113. The search results may be presented in any form that may be viewed by the user. Further, the search results may be formatted in any form that may be processed by computer system software.

In addition to forming search queries and searching database 130, the search and database building process disclosed in FIG. 2 may also include an optional Step 270 (shown in FIG. 2 with dotted lines) that adds the results of the claim interpretation process to a memory that is searchable by computer system 110, such as database 130 or memory device 112. In one embodiment, the claim interpretation process may store the modified claim portion generated in Step 250 to the memory. Additionally, or alternatively, the claim interpretation process may store in the memory, data reflecting the concept of the selected claim portion determined by the claim interpretation process. In this regard, the memory may include information reflecting the claim interpretations of the selected claim portion and of other claims, and portions thereof, that may have been previously processed by computer system 110 or stored in the memory by other means, such as a user or other computer executed software. The stored information may include data identifying a patent corresponding to the selected claim interpretation data. Accordingly, the search process may search the memory for prior art documents based on a search query generated in accordance with the above disclosed embodiments. Alternatively, computer system 110 may enable the memory to be searched based on search queries formed without the disclosed search and database building process executed by computer system 110.

In the exemplary embodiment disclosed above, the memory may be configured with one or more claim interpretation tables that store the claim interpretation data. Further, in addition to storing an identifier of the patent related to the claim interpretation data stored in the claim interpretation table, the memory may also include the patent or a portion thereof associated with each of the claim interpretation data. Thus, when the search process identifies claim interpretation data relevant to a generated search query, the search process may access the corresponding patent document from which the claim interpretation was obtained. In one embodiment, the patent may be stored in the claim interpretation tables. Alternatively, the patent may be stored in a data table that is separate from the claim interpretation data table within the memory. In this regard, disclosed embodiments include maintaining a logical link between the claim interpretation data stored in the claim interpretation table and the related patent stored in the separate table.

The claim interpretation data may be linked to the patent using any type of linking technique or process. For instance, primary keys may be implemented that identify the location of claim interpretation data in the claim interpretation table. For example, a primary key designated as “primary key 5”may be associated with certain claim interpretation data that is located in the claim interpretation table at “row 5, column 5.” The primary key may further correspond to a foreign key that is used to identify the corresponding patent. For example, primary key 5 may correspond to “foreign key 10,” which indicates the patent is stored in “row 10, column 10” of a table storing the patent documents.

It should be noted that any type of linking technique or process may be used to link the claim interpretation data to its corresponding patent by the disclosed embodiment.

In certain embodiments, the claim interpretation data determined at Step 250 may be added and retrieved from the memory (e.g., database 130, memory device 112) using one or more data addition/retrieval techniques. For example, if the claim interpretation data is stored in a flat file, computer system 110 may add data to the file using text addition software. Alternatively, if the memory is configured as a RDBMS, computer system 110 may execute software that adds data into the relational database, such as SQL-based software. Other techniques and processes suitable for adding and retrieving data to/from the memory may be employed by the disclosed embodiments.

### INDUSTRIAL APPLICABILITY

The disclosed embodiments may be used in any application designed to search for patents and other related printed publications related to the claims of a particular patent. These embodiments provide improvements over existing search systems and methods. For instance, the claims of a patent generally define the metes and bounds of the invention claimed by the patent. However, claim language by itself, may not provide the best possible basis for forming a search of related patent documents. Existing patent search methods and system that use keyword-based searches, natural language searches, and concept-based searches based solely on the terms of a claim may not yield relevant search results or search results commensurate with the full scope of the claimed invention of the target patent (i.e., the patent selected as the basis for the prior art search).

Further, existing search methods that base prior art searches solely on text from the specification of a patent may also not produce relevant search results because the specification may include extraneous terms that may not be directly related to the novelty of the claimed invention of the target patent. For example, the target patent's specification may include text that explain the differences between the described invention and prior art. This text, while useful to describe the distinguishing characteristics of the described invention, may not be relevant to the true scope of the invention disclosed in the patent or patent claims.

In contrast, the disclosed embodiments determine claim interpretation data based on comparisons of patent claim terms and associated text in the patent's disclosure. The claim interpretation data reflects conceptual meanings of a selected claim in the context of the selected patent. Based on the claim interpretation data, search queries are formed and searches are performed that locate prior art documents that are relevant to the search queries. Thus, the disclosed embodiments may provide more accurate search results with respect to prior art searches than existing search methods and systems.

The disclosed embodiments may be implemented in various environments and applications. Such environments and related applications may be specially constructed for performing the various processes and operations of the invention. The processes disclosed herein are not inherently related to any particular system, and may be implemented by a suitable combination of electrical-based components. Other embodiments of the invention will be apparent to those skilled in the art from consideration of the specification and practice of the disclosed embodiments. For instance, the sequence of the process performed in FIG. 2 is exemplary. That is, additional or fewer steps may be performed and/or different sequences may be performed by computer system 110. For example, in one embodiment, computer system 110 may execute software that generates text from figures included in the disclosure of a selected patent. The software may parse the figure data to form text that is stored in a memory location and linked to the text of the specification of the patent. In this regard, the portion of the disclosure selected in Step 230 of FIG. 2 may include the figure related text and thus be compared to the selected portion of the claim by the comparison process. Further, the software instructions executed by computer system 110 and processor 111 may be written in any programming language, such as C, C++, Pascal, Visual C++, Visual Basic or any other such language.

Additionally, although the disclosed embodiments are described as being associated with data stored in memory and other storage mediums, one skilled in the art will appreciate that these embodiments may also be stored on or read from other types of computer-readable media, such as secondary storage devices, like hard disks, floppy disks, optical storage devices, DVDs, or CD-ROM a carrier wave from a communication link or network, such as the Internet; or other forms of RAM or ROM. Accordingly, the disclosed embodiments are not limited to the above described examples, but instead are defined by the appended claims in light of their full scope of equivalents.

What is claimed is:

1. A method for searching patent-related documents performed by a computer system, comprising:
selecting a portion of a selected claim of a patent;
selecting a portion of a disclosure of the patent;
comparing the claim portion with the disclosure portion;
determining claim interpretation data associated with the portion of the claim based on the comparison; and
searching a database for patent-related documents relevant to the selected claim based on the claim interpretation data.

2. The method of claim 1, wherein selecting the portion of the disclosure includes:
selecting at least a portion of a dependent claim of the selected claim of the patent.

3. The method of claim 1, wherein selecting the portion of the disclosure includes:
selecting at least a portion of at least one of a specification of the patent and text associated with one or more figures of the patent.

4. The method of claim 1, wherein determining the claim interpretation data includes:
generating a modified version of the portion of the claim based on the comparison that reflects a meaning of the portion of the claim in the context of the disclosure portion.

5. The method of claim 1, wherein comparing the claim portion with the disclosure portion includes:
identifying text within the disclosure portion that corresponds to the claim portion.

6. The method of claim 6, wherein determining the claim interpretation data includes:
inserting the identified text in the claim portion to create a modified claim portion.

7. The method of claim 6, wherein searching includes:
generating a search query based on terms included in the modified claim portion; and
searching the database using the search query.

8. The method of claim 1, wherein comparing the claim portion with the disclosure portion includes:
identifying text within the disclosure portion that corresponds to a first claim term within the claim portion; and
generating a list for the first claim term including the identified text.

9. The method of claim 8, wherein determining the claim interpretation data further includes:
adding the text from the list to the claim portion to generate a modified claim portion, wherein the text is added to a location where the first claim term is present within the claim portion.

10. The method of claim 1, wherein determining the claim interpretation data includes:
adding the claim interpretation data to a claim interpretation database that stores claim interpretation data from other searches for patent-related documents.

11. The method of claim 10, wherein searching further includes:
searching the claim interpretation database for patent-related documents based on a search query formed from the claim interpretation data.

12. The method of claim 11, wherein searching further includes:
identifying a term within the claim interpretation data stored in the claim interpretation database that corresponds to the search query; and
identifying a patent-related document corresponding to the identified term within the claim interpretation data.

13. The method of claim 1, wherein selecting a portion of the selected claim includes:
selecting the portion of the selected claim based on selection criteria.

14. The method of claim 13, wherein the selection criteria is based on a structure of the selected claim.

15. A system for searching patent-related documents, comprising:
a computer system configured to:
select a portion of a selected claim of a patent;
select a portion of a disclosure of the patent;
compare the claim portion with the disclosure portion;
determine claim interpretation data associated with the portion of the claim based on the comparison, and
database system including patent-related documents,
wherein the computer system is further configured to send a search command to the database system to search for patent-related documents relevant to the selected claim portion based on the claim interpretation data.

16. The system of claim 15, wherein the computer system is configured to select at least a portion of a dependent claim of the selected claim of the patent as the selected claim portion.

17. The system of claim 15, wherein the computer system is configured to select at least a portion of at least one of a specification of the patent and text associated with one or more figures of the patent as the selected disclosure portion.

18. The system of claim 15, wherein the computer system is configure to generate a modified version of the portion of the selected claim based on the comparison that reflects a meaning of the portion of the selected claim in the context of the disclosure portion.

19. The system of claim 15, wherein the computer system is configured to identify text within the disclosure portion that corresponds to the claim portion.

20. The system of claim 19, wherein the computer system is configured to insert the identified text in the claim portion to create a modified claim portion.

21. The system of claim 20, wherein the computer system is configured to generate a search query based on terms included in the modified claim portion and generate the search command based on the search query.

22. The system of claim 15, wherein the computer system is configured to identify text within the disclosure portion that corresponds to a first claim term within the claim portion and generate a list for the first claim term including the identified text.

23. The system of claim 22, wherein the computer system is configured to add the text from the list to the claim portion to generate a modified claim portion, wherein the text is added to a location where the first claim term is present within the claim portion.

24. The system of claim 15, wherein the computer system is configured to add the claim interpretation data to a claim interpretation database that stores claim interpretation data from other searches for patent-related documents.

25. The system of claim 24, wherein the computer system is configured to search the claim interpretation database for patent-related documents based on a search query formed from the claim interpretation data.

26. A method for searching patent-related documents associated with a selected claim term within a patent, the method performed automatically by a computer system executing software comprising:
determining a context of the selected claim term in relation to a disclosure of the patent;
generating a search query based on the determined context of the selected claim term; and
searching a database to identify one or more of the patent-related documents that are relevant to the search query.

27. A computer-readable medium including instructions that, when executed by a processor, perform a method for searching patent-related documents associated with a selected claim term within a patent, the method comprising:
determining a context of the selected claim term in relation to a disclosure of the patent;
generating a search query based on the determined context of the selected claim term; and
searching a database to identify one or more of the patent-related documents that are relevant to the search query.
